(19) United States
(12) Patent Application Publication
(10) Pub. No.: US 2008/0207187 A1
(43) Pub. Date: Aug. 28, 2008

(54) Multimode Mobile Terminal With Automatic Selection of Interface of Radio Access Network During a Service Session

(75) Inventor: Hervé Maillard, Igny (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL LUCENT, Paris (FR)

(21) Appl. No.: 11/916,742

(22) PCT Filed: Jun. 5, 2006
(86) PCT No.: PCT/FR2006/050518

§ 371 Date: Jan. 29, 2008

(30) Foreign Application Priority Data
Jun. 7, 2005 (FR) 0551523

(51) Int. Cl. H04M 3/00

(52) U.S. Cl. 455/418

(57) ABSTRACT

The invention concerns a radio communication mobile terminal (MS) comprising: i) an operating system (OS), ii) at least one internal application (IA1) for exchanging data with a at last one external application (EA) implanted in a network equipment (SE); iii) at least two network interfaces (NI1, NI2) connected to the operating system (OS), each provided with an address and capable of being respectively coupled with radio access networks (RAN1, RAN2) of different types and connected to a network backbone (IPN) which is coupled the network equipment (SE), and iv) control means for (CM) providing an interfacing proxy function between internal (IA1) and external (EA) applications and serving, each time they receive a transaction request from the internal application (IA1) and designating an external application (EA), to determine among the network interfaces (NI1, NI2) the one which is adapted to the transaction based on the control data and the routing data, then to order the operating system (S) to transmit the transaction request to the designated external application (EA) via a transport level connection between the determined interface network and the network equipment (SE) containing the external application (EA).

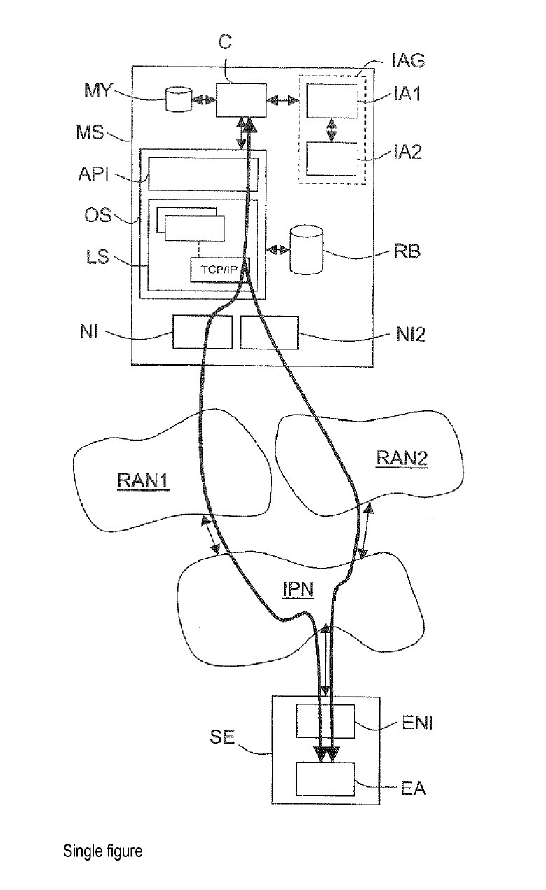

The invention relates to groups of radiocommunication networks coupled to each other via a backbone network and more precisely to controlling the access of mobile terminals to radio access networks for communicating with external applications during service sessions.

In the present context, the expression “mobile terminal” refers to any mobile or portable radiocommunication terminal capable of exchanging data in the form of radio signals either with another terminal or network equipment via their parent network(s) or with its own parent network, for example mobile telephones and portable (laptop) computers or personal digital assistants (PDA) equipped with radiocommunication modules.

Some mobile terminals, known as multimode terminals, are adapted to access a plurality of (at least two) different radio access networks, for example, on the one hand, GPRS/EDGE and/or UMTS communication networks and, on the other hand, WLAN and/or WiFi and/or WiMAX communication networks. These terminals therefore have a plurality of network interfaces defined on telephone (GPRS/EDGE or UMTS) or PCMCIA (WiFi or WiMAX) electronic communication cards, for example, enabling them to connect to the corresponding radio access networks. It is also possible to constitute a “multimode” terminal by combining two mobile terminals, for example a mobile telephone connected via a serial port to a portable (laptop) computer.

For example, if the backbone network to which the radio access networks are coupled is an Internet Protocol (IP) network, the multimode terminals can connect via the radio access networks to network (or application) equipments coupled to the Internet Protocol network and including external application servers (or Internet sites) in order to exchange data with those servers. For example, an external application may be dedicated to transmitting music or video (“streaming” mode transmission of audio, video and like data streams).

For the user of a multimode terminal to be able to download data managed by a remote external application, his terminal must have an internal application, for example a web browser, capable of initiating a service session with said external application.

As the person skilled in the art is aware, a service session is made up of (service) transactions of different types defined by specific characteristics and associated with service semantics. The service semantic defines the sense of a given transaction given the application concerned. For example, a transaction may consist in looking for an Internet site or a given page of an Internet site, requesting the transmission of a film, or requesting the temporary or permanent stopping of a film.

Each transaction emanating from an (internal or external) requesting application must be transmitted to the requested (external or internal) application that it designates via a transport (socket) level connection set up between the equipments (for example a multimode terminal and an application server) in which the requesting and requested applications (internal and external) are installed.

Successive transactions of the same type or of different types during the same session do not necessarily require to use the same high bit rate or even very high bit rate (transport level) connection. For example, it is of no utility to use a very high bit rate connection to transmit a request for temporary or permanent stopping of the transmission of video data, whereas video data transmission itself necessitates a very high bit rate connection.

Likewise, under certain circumstances, it would be desirable to wait briefly for access to a high bit rate connection to be possible, rather than to initiate immediately a session using a lower bit rate connection leading to a lower quality of reproduction. For example, if a UMTS/WiFi bimode terminal were to be moved in an area in which there are WiFi hot spots, it would be advantageous to wait in order to transmit high bit rate video data to it via the WiFi access network each time that it reaches a hot spot.

It follows from the above analysis that it would be particularly advantageous to be able to choose a radio access network suited to each transaction that a multimode terminal requires to perform. This is not possible at present.

Multimode terminals such as portable (laptop) computers and PDAs are at present adapted to select the network interface to be used to access a requested application as a function of the destination address of the application equipment in which the requested application is installed and the route (or path) that is in particular associated with that destination address in the routing table of the multimode terminal.

Consequently, if a route of this kind exists in the routing table, the requesting application is obliged to select the network interface that is connected to the radio access network through which that route passes. If no such route exists in the routing table, the requesting application is obliged to use a default route that is linked to a network interface providing connectivity to a single radio access network. Thus in practice the network interface linked to the default route is systematically used unless it is not available.

In current multimode terminals, the requesting (internal) application therefore has no control over the network interfaces that are used to perform transactions.

In an attempt to improve on this situation, Alcatel has proposed modifying the operating system of the multimode terminals in order to enrich the API socket (transport level connection application programming interface) layer and to modify the internal applications in order for them to be able to use access network selection mechanisms capable of using the modifications made to the API socket layer. This solution obliges the manufacturers of multimode terminal internal applications to modify them and does not enable radio access network operators to have any input with respect to the mode of selecting their access networks, which significantly restricts the selection criteria.

An object of the invention is to improve on this situation.

To this end it proposes a multimode mobile (radio communication) terminal, comprising an operating system, at least one internal application for exchanging data with at least one external application installed in a network equipment, at least two network interfaces coupled to the operating system, each having an address and being able to be connected to respective radio access networks of different types and connected to a backbone network to which the network equipment is connected.

This multimode terminal is characterized in that it comprises control means to provide a proxy interface function between internal applications and external applications and adapted each time that they receive a transaction request from the internal application designating an external application to determine which of the network interfaces of its terminal is suited to the transaction as a function of control information and routing information and then to instruct the operating system to transmit the transaction request to the designated external application via a transport (socket) level connection between the determined network interface and the network equipment containing the external application.

In the present context, the expression “proxy function” refers to a module interleaved between two applications and passing itself off as one of the two applications to the other application, and vice-versa, in accordance with the IETF definition.

The multimode mobile terminal of the invention may have other features, and in particular, separately or in combination:
its control means are adapted, firstly, to select a network interface as a function of the control information, secondly, to check whether there exists in the routing information (stored in a routing table of the terminal), a route that would be used in the context of a call to the network equipment containing the external application that the requested transaction concerns, and, thirdly, to instruct the storage in the routing table of routing information defining a route involving the use of the selected network interface, if no such route is defined in said table;
in case of unavailability of the selected network interface, its control means can be responsible for determining another network interface as a function of the control information and the routing information;
its control means can be responsible for determining the network interface by means of system commands transmitted to the operating system;
its control means can take the form of a downloadable proxy type software application. In this case the operating system is adapted, firstly, to receive the proxy type software application from a remote auxiliary network equipment, secondly, to install that proxy type software application in the terminal at a chosen internal address, and, thirdly, to communicate the chosen internal address to each internal application so that it can communicate with the proxy type software application;
the control data can be stored in a remote auxiliary network equipment. In this case its control means are responsible for requesting the operating system to set up a signaling connection between the terminal and that auxiliary network equipment so that the latter can transmit the control data to them;
its control means can be responsible for requesting the control information from the auxiliary network equipment via the signaling connection to store them in memory means of the terminal;
in a first variant, its control means can be responsible for storing in the memory means of the terminal the control data transmitted by the auxiliary network equipment (at its initiative) via the signaling connection;
in a second variant, its control means can be responsible for requesting from the auxiliary network equipment, via the signaling connection, the control data necessary for determining a network interface for a transaction to be transmitted;
the control information is chosen, for example, from application type data associated with network interface type data, transaction type data associated with network interface type data, application type data and transaction type data associated with network interface type data, data representing the weight of the data to be transmitted to an internal application associated with network interface type data, and network information data associated with network interface type data;
in the presence of an Internet Protocol (IP) backbone network its control means can be responsible for communicating with each internal application by means of a transport protocol chosen from UDP, TCP/IP and SCTP;
its control means can be responsible for communicating with each external application by means of a hypertext transport protocol (HTTP (HyperText Transmission Protocol)).

Other features and advantages of the invention will become apparent on reading the following detailed description and examining the appended drawings, the single figure in which shows very diagrammatically a dual mode terminal according to the invention, coupled to an external application server via two radio access networks and a backbone network. The appended drawing constitutes part of the description of the invention as well as contributing to the definition of the invention, if necessary.

An object of the invention is to enable automatic selection of radio access networks at the level of the multimode radio communication mobile terminals during service sessions.

The multimode radiocommunication mobile terminals considered hereinafter by way of nonlimiting example are bimode portable computers equipped with a WiFi PCMCIA card and a UMTS mobile telephone card. However, the invention is not limited to this application alone, of course. It relates to all mobile or portable multimode communication terminals capable of exchange data in the form of radio signals either with another terminal or network equipment via their parent network(s) or with its own parent network, for example multimode mobile telephones or personal digital assistants (PDA). Moreover, the invention is not limited to UMTS/WiFi bimode terminals. It relates to all mobile terminals capable of accessing at least two radio access networks of different types using at least two network interfaces corresponding to said different types and each having its own address. Thus the invention relates in particular to the following network interface combinations: GSM and/or GPRS/EDGE and/or UMTS (or HSDPA) and/or WLAN (wireless local area network, for example a Hyperlan network (according to the ETSI standard) or an 802.11 network (according to the IEEE standard)) and/or WMAN (wireless metropolitan area network, for example an 802.16 network according to the IEEE standard) and/or Bluetooth.

The single figure shows by way of example the multimode mobile terminal (a laptop computer, for example) MS, which conventionally comprises:
an operating system OS, for example Windows or Linux, including in particular an application programming interface API and a layer stack LS including a transport layer, for example of the TCP/IP type,
a database RB which is coupled to the operating system OS and which stores routing data defining routes (or paths) providing access to remote equipments designated by addresses known as destination addresses, for example IP addresses, this database taking the form of a routing table; to be more precise, each entry in the routing table is a destination address,
a group IAG of at least one internal application IA1 enabling exchange of data with at least one external application EA implemented in a remote application equipment SE; for example, the internal application IA is a web browser coupled to another internal application IA2 dedicated to playback of videos, and the external application EA is an application dedicated to video streaming, and
at least two network interfaces NI1 and NI2 coupled to the operating system OS and adapted to be connected to two radio access networks RAN1 and RAN2 of different type, UMTS in the case of RAN1 and WiFi in the case of RAN2, for example, respectively, and each having an IP address, for example.

The two radio access networks RAN1 and RAN2 are also connected to a backbone network IPN, for example an Internet Protocol (IP) network such as the Internet.

The remote network equipment SE is also connected to the backbone network IPN. It is an application server, for example, having an address, for example an IP address, and containing at least the external application EA.

According to the invention, the multimode terminal MS further comprises a control module CM providing a “proxy” interface function between the set IAG of internal applications IA1 and IA2 and the external applications EA.

As indicated above, the definition of the proxy function is here the IETF definition. Consequently, it consists of a software (or electronic data processing) module and/or an electronic circuit interleaved between internal applications (here applications IA1 and IA2) and external applications (here application EA) and passing itself off as one application to another application and vice-versa.

Each time that an internal application IAi (here i=1 or 2) sends it a service transaction request designating an external application EA during a service session the control module CM with the proxy function determines as a function of control information and routing information which of the network interfaces NIj (here j=1 or 2) is the one that is suited to the transaction.

In the present context, the expression “routing information” refers to routing data stored in the routing table of the database RB and to availability data indicating if the network interfaces NIj are connected to the corresponding radio access networks RANj or not.

For example, exchanges between an internal application IAi and the control module CM may be effected in accordance with a transport protocol such as the UDP (User Datagram Protocol), TCP/IP (Transmission Control Protocol/Internet Protocol) or SCTP (Streaming Control Transport Protocol), among others.

According to version 4 of the Internet Protocol (IPv4), the control module CM has an internal address (known to the person skilled in the art as a loopback address), such as the address 127.0.0.1. This internal address, which designates the port number of the control module CM, is known to each internal application IAi of the group IAG. It is integrated into the header of the IP packets containing the transaction request to be transmitted, just like the destination address designating the network equipment SE containing the external application EA to which the requested transaction relates.

The control module CM accesses the routing data by sending system commands to the operating system OS that is coupled to the database RB in which the routing table is stored. The control module CM also accesses the availability data by sending system commands to the operating system OS, to be more precise to its API.

In the present context the expression “control information” refers to any data specifying a type of network interface NIj to be used in corresponding relationship to an internal application type and/or a transaction type and/or network information.

The transaction type designates not only one or more operations to be effected but also what the person skilled in the art refers to as the service semantic associated with the transaction. The designation of an operation to be effected may include information relating to the weight of a video file to be downloaded, for example.

The network information may consist of information data representing the costs of access to the various radio access networks RANj or of load balancing information data, for example.

The control information defines as it were a table that matches a given network interface NIj to a given situation defined by a designated internal application and/or a requested transaction and/or network information. Accordingly, each time that the control module CM receives a transaction request to be transmitted to an external application EA, it determines the present situation (defined by the control information available to it) and selects the network interface NIj that corresponds to that situation and that the operating system OS must use to transmit the transaction request to the designated external application EA, provided that it is available.

The control information may be stored in a multimode terminal MS in memory means MY that can take any form, in particular the form of a memory or a database.

Some at least of the control information may be downloaded, by a remote auxiliary network equipment (not shown) belonging, for example, to the operator of the communication network or networks to which the user of the multimode terminal MS subscribes.

Control information can be downloaded at the initiative of the auxiliary network equipment, for example periodically, each time that an event occurs in the network or when new internal or external applications come onto the market. However, downloading control information at the initiative of a control module CM may equally be envisaged, for example periodically, each time an internal application of a new type is installed in the multimode terminal MS or an unknown external application is designated, or each time that a transaction request that is to be transmitted is received (in this case, no control information data is stored in the multimode terminal MS and the control module CM has only to verify the availability of the network interface NIj proposed to it by the auxiliary network equipment).

Instead of this, or in addition to this, at least some of the control information can be stored in the multimode terminal MS when the control module CM is installed.

A basic version of the invention may also be envisaged in which the control information is reduced to a table of correspondences in which each type of application is associated with a type of network interface. In this case, the control information may directly form part of the control module CM.

Once a control module CM has selected the network interface NIj suited to the situation (using the control information available to it), it gives preference to sending system commands to the operating system OS in order to check if the routing information stored in the routing table of the database RB already contains a route defining a transport (socket) level connection between the selected network interface NIj and the network equipment SE containing the external application EA to which the requested transaction relates. In other words, the control module CM checks if any of the entries in the routing table consists of an (IP) destination address designating the network equipment SE that contains the external application EA to which the requested transaction relates.

It is important to note that the destination address is not necessarily that of the network equipment SE. It may be an address of a network to which the network equipment SE is connected or of a portion of that network.

If the route is defined in the routing table, then the control module CM gives preference to checking the availability of the network interface NIj that it has selected. Here the term “availability” refers to the fact that the network interface NIj is usable (enabled). It may happen that a network interface has lost connectivity with the network. To this end, the control module CM gives preference to sending system commands to the operating system OS, to be more precise to its connection interface API (socket API). System commands such as “IPCONFIG” (in Windows) and “IFCONFIG” (in Linux) enable an internal proxy function (here CM) to determine the availability status of the network interfaces NIj and their identifiers.

If the network interface NIj selected is available, then the control module CM considers it to be the determined network interface. It then instructs the operating system OS to transmit the transaction request to the designated external application EA via the transport (socket) level connection set up between the determined network interface NIj and the network equipment SE that contains the external application EA.

For example, the control module CM transmits its instructions to the operating system OS by means of a hypertext transport protocol such as HTTP (HyperText Transmission Protocol) suitable for communication with the external applications EA.

If the selected network interface NIj is not available, then the control module CM must select another.

If the route to the requested external application EA is not defined in the routing table the control module CM gives preference to sending system commands to the operating system OS in order for it to create that route and integrate its definition into the routing table of the database RB. System commands such as “ROUTE ADD IP@ mask NI-identifier” enable new entries to be incorporated into the routing table. There are also system commands for eliminating entries from the routing table.

Once the route has been incorporated into the routing table the control module CM gives preference to checking the availability of the network interface NIj that it has selected. If the network interface NIj selected is available, the control module CM considers it to be the determined network interface. It then instructs the operating system OS to transmit the transaction request to the designated external application EA via the transport (socket) level connection set up between the determined network interface NIj and the network equipment SE that contains the external application EA. If the network interface is not available, the control module CM must select another (available) network interface.

It is important to note that the control module CM can be installed in the multimode terminal MS during its fabrication. However, it can equally be installed by downloading it from a remote auxiliary network equipment (not shown), where applicable that which can supply control information. In this case, the control module CM can take the form of what the person skilled in the art knows as a “proxylet”, for example. This downloading can be effected, for example, at the initiative of the operator of the communication network or networks to which the user of the multimode terminal MS subscribes, for example following the user subscribing to an automatic radio access network selection option.

Generally speaking, the control module CM of the multimode terminal MS, and its memory MY, where applicable, can be produced in the form of electronic circuits, software (or electronic data processing) modules, or a combination of circuits and software.

Three applications are briefly described next by way of nonlimiting example.

The first example relates to selecting radio access network interfaces as a function of the type of transaction to be transmitted and assumes that the multimode terminal MS can access discontinuous coverage wireless networks and UMTS mobile networks. Discontinuous coverage access was designed to offer a very high data bit at low cost for relatively long and non-interactive traffic (and therefore for transactions that are not in real time), such as streaming and background data streams. Moreover, UMTS access is suitable for relatively short interactive transactions.

During a streaming session, both access networks may be used according to the type of transaction to be transmitted. Thus the control module CM may decide to transmit via the UMTS network interface RTSP (Real Time Streaming Protocol) messages that in particular contain transactions for selecting a file to be viewed, exchanging parameters, configuring connections or requesting the stopping or rewinding of a video and for transmitting video data streams via the network interface dedicated to discontinuous coverage. The selection made by the control module CM can also take into account other control information, for example the cost of access to the two radio access networks and/or the weight (in bytes) of the video files to be downloaded.

The second example relates to selecting radio access network interfaces as a function of load balancing information. It is assumed here that a user is browsing the Internet using the browser NI1 installed on his multimode terminal MS and connected to the Internet via a wireless local area network (WLAN) consisting of “hot spots” for which the access networks are almost saturated. To prevent browsing quality from being degraded by the saturation of the hot spots, the control module CM may decide to change the network interface and therefore the access network at least temporarily to transmit “HTTP GET” messages coming from the browser NI1.

The third example relates to selecting radio access network interfaces as a function of the internal application type. The downloaded control module CM of a multimode terminal MS can be configured so that Voice over IP (VoIP) internal applications all use the network interface connected to the UMTS radio access network whereas the Internet browser internal application uses the network interface connected to a wireless local area network (WLAN).

The invention is not limited to the multimode mobile terminal embodiments described above by way of example only and encompasses all variants that the person skilled in the art might envisage that fall within the scope of the following claims.

1. Mobile radio communication terminal (MS), comprising an operating system (OS), at least one internal application (IA1) adapted to exchange data with at least one external application (EA) installed in a network equipment (SE), at least two network interfaces (NI1, NI2) coupled to said operating system (OS), each having an address and adapted to be connected to respective radio access networks (RAN1, RAN2) of different types and connected to a backbone network (IPN) to which said network equipment (SE) is connected, characterized in that it comprises control means (CM) to provide a proxy interface function between internal applications (IA1) and external applications (EA) adapted, in case of reception of a transaction request from said internal application (IA1) designating an external application (EA) to determine which of said network interfaces (NI1,NI2) is suited to said transaction as a function of control information and routing information and then to instruct said operating system (OS) to transmit said transaction request to said designated external application (EA) via a transport level connection between said determined network interface and the network equipment (SE) containing said external application (EA).

2. Mobile terminal according to claim 1, characterized in that said control means (CM) are adapted i) to select a network interface (NIj) as a function of said control information, then ii) to check whether there exists in said routing information, stored in a routing table of said terminal (MS), a route involving said selected network interface and the network equipment (SE) containing said external application (EA) that said requested transaction concerns, and iii) either to identify said network interface to said selected network interface if said group is defined, or to instruct the storage in said routing table of routing information defining said route if the latter has not yet been defined, and then to identify said network interface to said selected network interface and to instruct said operating system (OS) to create the transport level connection corresponding to that route.

3. Mobile terminal according to claim 2, characterized in that in case of unavailability of said selected network interface (NI1), said control means (CM) are adapted to determine another network interface (NI2) as a function of said control information and said routing information.

4. Mobile terminal according to claim 1, characterized in that said control means (CM) are adapted to determine said network interface (NIj) by transmission of system commands to said operating system (OS).

5. Mobile terminal according to claim 1, characterized in that said control means (CM) take the form of a downloadable proxy type software application, and in that said operating system (OS) is adapted i) to receive said proxy type software application (CM) from a remote auxiliary network equipment, then ii) to install that proxy type software application (CM) in said terminal (MS) at a chosen internal address, and iii) to communicate said chosen internal address to each internal application (IA1) so that it can communicate with said proxy type software application (CM).

6. Mobile terminal according to claim 1, characterized in that said control data is stored in a remote auxiliary network equipment, and in that said control means (CM) are adapted to request said operating system (OS) to set up a signaling connection between said terminal (MS) and that auxiliary network equipment so that the latter can transmit said control data to them.

7. Mobile terminal according to claim 6, characterized in that said control means (CM) are adapted to request said control information from said auxiliary network equipment via said signaling connection to store them in memory means (MY) of said terminal (MS).

8. Mobile terminal according to claim 6, characterized in that said control means (CM) are adapted to store in the memory means (MY) of said terminal (MS) said control data transmitted by said auxiliary network equipment via said signaling connection.

9. Mobile terminal according to claim 6, characterized in that said control means (CM) are adapted to request from said auxiliary network equipment, via said signaling connection, said control data necessary for determining a network interface (NIj) for a transaction to be transmitted.

10. Mobile terminal according to claim 1, characterized in that said control information is chosen in a group comprising at least application type data associated with network interface type data, transaction type data associated with network interface type data, application type data and transaction type data associated with network interface type data, data representing the weight of the data to be transmitted to an internal application associated with network interface type data, and network information data associated with network interface type data.

11. Mobile terminal according to claim 1, characterized in that in the presence of an Internet protocol (IP) backbone network (IPN) said control means (CM) are adapted to communicate with each internal application (IA1) by means of a transport protocol chosen from UDP, TCP/IP and SCTP.

12. Mobile terminal according to claim 11, characterized in that said control means (CM) are adapted to communicate with each external application (EA) by means of a hypertext transport protocol (HTTP).
